(19) United States
(12) Patent Application Publication
(10) Pub. No.: US 2025/0020823 A1
(43) Pub. Date: Jan. 16, 2025

(54) RUN DATA CALIBRATION AND MACHINE LEARNING SYSTEM FOR WELL FACILITIES

(71) Applicant: HALLIBURTON ENERGY SERVICES, INC., Houston, TX (US)

(72) Inventors: Christina Marie HARRINGTON, Tulsa, OK (US); Bobby Neal ARMSTRONG, Claremore, OK (US); Travis Chet JOHNSON, Tulsa, OK (US)

(73) Assignee: HALLIBURTON ENERGY SERVICES, INC., Houston, TX (US)

(21) Appl. No.: 18/350,213

(22) Filed: Jul. 11, 2023

(51) Int. Cl. G01V 1/50; G01V 1/46

(52) U.S. Cl. CPC G01V 1/50; G01V 1/46

(57) ABSTRACT

Disclosed are systems, apparatuses, methods, and computer readable medium for run data based on operation of a facility. A method includes: analyzing tickets identifying modification of a plurality of equipment installed and configured at the facility, wherein a ticket identifies at least one of an installation of a first equipment, removal of the first equipment, or testing of the first equipment; generating a plurality of runs based on the tickets, wherein each run of the plurality of runs identifies an equipment configuration, a start time, and an end time; and mapping measurement data from the equipment based on the equipment configuration of the run into time series data.

### TECHNICAL FIELD

The present technology pertains to a well system for extracting materials, and more particularly, to run data calibration and a machine learning system for well facilities.

### BACKGROUND

A well system comprises a well-drilling system to form the well and a well-pumping system to retrieve materials from the well. A well-drilling system is a setup of equipment and machinery designed to extract natural resources, such as water, oil, or gas, from the ground. The system typically includes a drilling rig, which is used to bore a hole into the earth's crust, and a casing, which is a steel pipe that lines the well and prevents the walls from collapsing. The drilling process begins with the placement of a drill bit at the end of a drill string. The drill bit is then rotated, using a motor or a manual mechanism, to create a hole in the ground. As the hole is drilled, the drill string is gradually lengthened by adding more sections of pipe. The process continues until the desired depth is reached.

Once the drilling is complete, a casing is installed into the well to protect it from collapse and prevent contamination of the extracted resources. The casing is typically cemented into place to seal off any potential pathways for groundwater to enter the well. Once the well is prepared, a well-pumping system is installed to extract the resources from the well. The type of pump used depends on the type of resource being extracted, as well as the depth and diameter of the well. For example, a submersible pump, a sub pump, or a reciprocating pump may be used for an oil well.

### BRIEF DESCRIPTION OF THE DRAWINGS

In order to describe the manner in which the various advantages and features of the disclosure may be obtained, a more particular description of the principles described herein will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1A is a schematic diagram of an example logging while drilling (LWD) wellbore operating environment in accordance with various aspects of the disclosure;

FIG. 1B is a diagram of an example downhole environment having tubulars, in accordance with various aspects of the disclosure;

FIG. 2 illustrates a block diagram of a system 200 for calibrating runtime data from a plurality of offline and online equipment in accordance with some aspects of the disclosure;

FIG. 3 is an illustration of data formats associated with various records to enable the calibration of run data in accordance with some aspects of the disclosure;

FIG. 4 is a conceptual illustration of run instances based on an operation of a facility in accordance with some aspects of the disclosure;

FIG. 5 is a block diagram of a runtime system that uses a machine learning model to facilitate operations of a facility in accordance with some aspects of the disclosure;

FIG. 6 is a user interface associated with a client application of a facility that performs data ingestion associated with equipment, cleaning of the data, and calibrating the data in accordance with some aspects of the disclosure; and

FIG. 7 illustrates an example method for calibrating runtime data of a facility such as a well drilling site or a well pumping site in accordance with some aspects of the disclosure; and

FIG. 8 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously described, a well system (or a well site) includes a large number of interoperating components, and many of these components experience wear and tear, failure, adverse conditions, and other general issues that may affect operation of the well site. In one illustrative aspect, an electric submersible pump system, which is also referred to as an artificial lift pumping system, can be deployed into the downhole environment (e.g., into the well) and experiences high temperature, immense pressure, fluid-borne abrasives, excessive gas, scale, and variable flow rate environments. In some cases, operators of the well site may implement a records system to document operation of the various components, adverse conditions, and data related to the adverse conditions. One type of record is a reliability report that an operator of a well site fills out to identify adverse conditions and operation, and the data related to the adverse conditions may include notes pertaining to actions taken, results of those actions, and so forth. The reliability records are then entered into a data storage location (e.g., a simple file system hierarchy, a paper filing system, etc.).

Another type of data is the data of the various equipment (also referred to as components) of the well system during operation. Because the various equipment have different requirements and are separate, the equipment can store data in different formats with different parameters, such as a recordation interval, accuracy, and so forth. The equipment can also have different time references, store data in different locations, and does not have any relationship to associate measurements from other equipment. There is significant difficulty in analyzing all of the data from different equipment based on the data being in different locations, different formats, and other issues noted above.

In addition, the data from the different equipment cannot be used in a machine learning operation because of the different issues noted above. In the event the data from different equipment are provided to a deep learning neural network for training, a significant amount of measurements will appear as noise to the deep learning neural network and reduce the accuracy of the model, as well as significantly increase the training time.

The disclosed technology addresses the foregoing by using records available to a system to identify events within a facility (e.g., a well site) and calibrating the data based on the identified events. In one aspect, the events may be associated with event records that identify change operations within the facility. The event records can have different names such as a pull ticket, an install ticket, a change request, etc., and identify some events. The disclosed technology uses the event records to identify the runtime operation of equipment at the facility and calibrate the data from the different equipment. In one aspect, the event records and runtime operation of the equipment can be mapped into a supervisory control and data acquisition (SCADA) system to align the measurements into time series data. As further described below, in some cases, data from various equipment cannot be provided during runtime operation, such as a part of a downhole pumping system that is disposed within a well, and the data can be later combined with existing measurements offline (e.g. when the equipment is removed from the well).

Various aspects include a system including one or more processors and at least one computer-readable storage medium storing instructions which, when executed by the one or more processors, cause the one or more processors to analyze tickets identifying modification of a plurality of equipment installed and configured at the facility, wherein a ticket identifies at least one of an installation of a first equipment, removal of the first equipment, or testing of the first equipment; generate a plurality of runs based on the tickets, wherein each run of the plurality of runs identifies an equipment configuration, a start time, and an end time; and map measurement data from the equipment based on the equipment configuration of the run into time series data.

Additional details and aspects of the present disclosure are described in more detail below with respect to the figures.

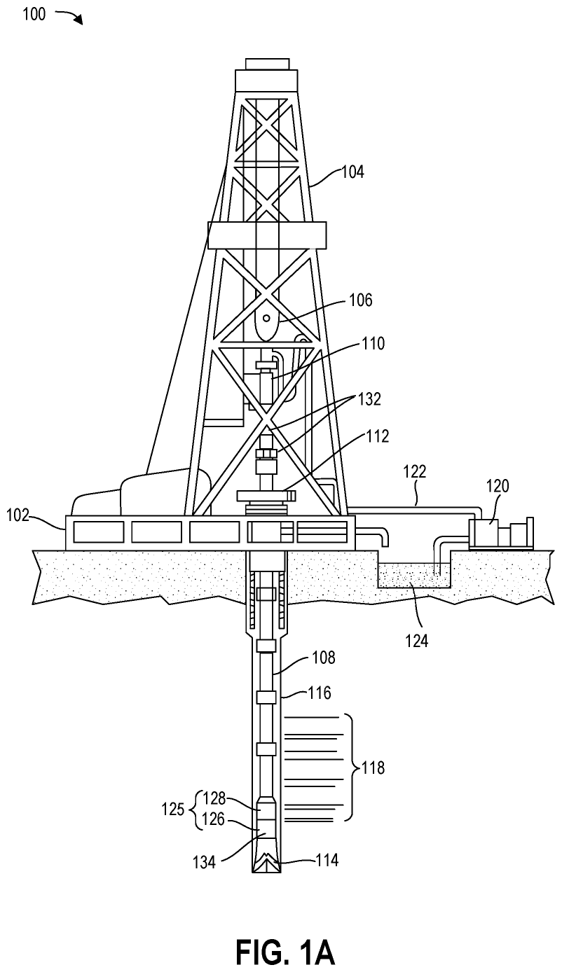

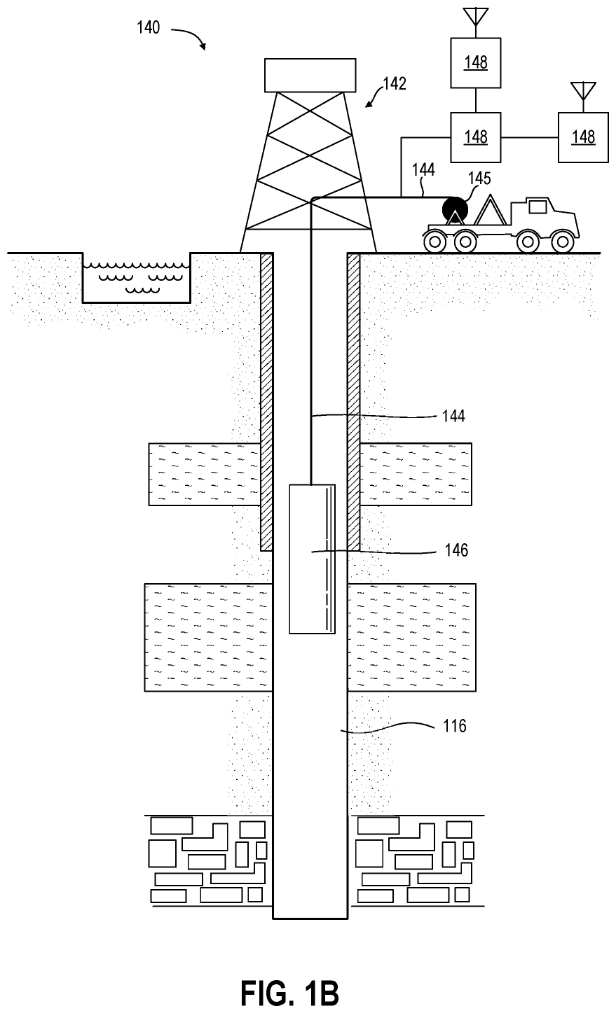

FIG. 1A is a schematic diagram of an example logging while drilling (LWD) operating environment of a well site, in accordance with various aspects of the disclosure.

In some aspects, a drilling arrangement is shown that exemplifies a LWD configuration in a wellbore drilling scenario 100. The LWD typically incorporates sensors that acquire formation data. The drilling arrangement of FIG. 1A also exemplifies measurement while drilling (MWD) and utilizes sensors to acquire data from which the wellbore's path and position in three-dimensional space may be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 may be connected to the lower end of the drill string 108. As the drill bit 114 rotates, the drill bit 114 creates a wellbore 116 that passes through one or more subterranean formations 118. A pump 120 circulates drilling fluid through a supply pipe 122 to top drive 110, down through the interior of the drill string 108, and out orifices in the drill bit 114 into the wellbore. The drilling fluid returns to the surface via the annulus around the drill string 108, and into a retention pit 124. The drilling fluid transports cuttings from the wellbore 116 into the retention pit 124 and the drilling fluid's presence in the annulus aids in maintaining the integrity of the wellbore 116. Various materials may be used for drilling fluid, including oil-based fluids and water-based fluids.

In some aspects, one or more logging tools 126 may be integrated into the bottom-hole assembly 125 near the drill bit 114. As the drill bit 114 extends the wellbore 116 through the subterranean formations 118, logging tools 126 collect measurements relating to various formation properties as well as the orientation of the tool and various other drilling conditions. In some cases, the logging tools interface with various sensors and equipment. The bottom-hole assembly 125 may also include a telemetry sub 128 to transfer measurement data to a surface receiver 132 and to receive commands from the surface. In at least some cases, the telemetry sub 128 communicates with a surface receiver 132 using mud pulse telemetry. In some instances, the telemetry sub 128 does not communicate with the surface, but rather stores logging data for later retrieval at the surface when the logging assembly is recovered.

Each of the logging tools 126 may include one or more tool components spaced apart from each other and communicatively coupled by one or more wires and/or another communication arrangement. The logging tools 126 may also include one or more computing devices communicatively coupled with one or more of the tool components. The one or more computing devices may be configured to control or monitor the performance of the tool, process logging data, and/or carry out one or more aspects of the methods and processes of the present disclosure.

In at least some instances, one or more of the logging tools 126 may communicate with a surface receiver 132 by a wire, such as a wired drill pipe. In other cases, the one or more of the logging tools 126 may communicate with a surface receiver 132 by wireless signal transmission, such as ground penetrating radar. In at least some cases, one or more of the logging tools 126 may receive electrical power from a wire that extends to the surface, including wires extending through a wired drill pipe.

In some aspects, a collar 134 is a frequent component of a drill string 108 and generally resembles a very thick-walled cylindrical pipe, typically with threaded ends and a hollow core for the conveyance of drilling fluid. In some cases, multiple collars 134 may be included in the drill string 108 and are constructed and intended to be heavy to apply weight on the drill bit 114 to assist the drilling process. Because of the thickness of the collar's wall, pocket-type cutouts or other type recesses may be provided into the collar's wall without negatively impacting the integrity (strength, rigidity, and the like) of the collar 134 as a component of the drill string 108.

FIG. 1B is a diagram of an example downhole environment having tubulars in accordance with various aspects of the disclosure. In some aspects, an example system 140 is depicted for conducting downhole measurements after at least a portion of a wellbore has been drilled and the drill string removed from the well. A downhole tool is shown having a tool body 146 to perform logging, measurements, and/or other operations. For example, instead of using the drill string 108 of FIG. 1A to lower a tool body 146, which may contain sensors and/or other instrumentation for detecting and logging nearby characteristics and conditions of the wellbore 116 and surrounding formations, a wireline conveyance 144 may be used.

The tool body 146 may be lowered into the wellbore 116 by wireline conveyance 144. The wireline conveyance 144 may be anchored in the drill rig 142 or by a portable device such as a truck 145. The wireline conveyance 144 may include one or more wires, slicklines, cables, and/or the like, as well as tubular conveyances such as coiled tubing, joint tubing, or other tubulars.

The wireline conveyance 144 provides power and support for the tool, as well as enabling communication between processing systems 148 on the surface. In some examples, the wireline conveyance 144 may include electrical and/or fiber optic cabling for performing any communications. The wireline conveyance 144 is sufficiently strong and flexible to tether the tool body 146 through the wellbore 116, while also permitting communication through the wireline conveyance 144 to one or more of the processing systems 148, which may include local and/or remote processors. In some cases, power may be supplied via the wireline conveyance 144 to meet the power requirements of the tool. For slickline or coiled tubing configurations, power may be supplied downhole with a battery or via a downhole generator.

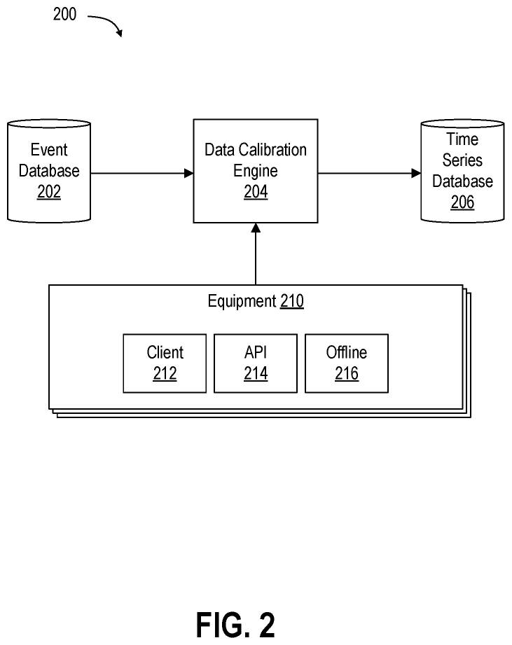

FIG. 2 illustrates a block diagram of a system 200 for calibrating runtime data from a plurality of offline and online equipment in accordance with some aspects of the disclosure. In one aspect, the offline and online equipment may be disposed at a facility such as a well. In one example, the equipment may be used as part of a well drilling operation to configure a well in connection with extracting resources. In another example, the equipment may be used as part of a well-pumping operation to extract resources within a well.

In some aspects, the system 200 includes an event database 202, a data calibration engine 204, a time-series database 206, and a plurality of equipment 210. The event database 202 collects various items that identify events associated with the well site, for example, the equipment installed at various points. As noted above, in some cases, the equipment may be submersible and disposed within the well to perform various functions, such as extract materials, perform initial filtering operations, restrict or permit liquid flow, measure various parameters (e.g., pressure, temperature, etc.), and so forth. As an example, a submersible electric pump may include mechanical and electrical components and may include a variety of sensors to detect information for an operator to guide operation. A portion of the sensors may be connected with a drill string, while at least one other sensor may be unable to electrically connect based on its position proximate to various moving parts of the submersible electric pump.

In some cases, multiple equipment may be fixed to provide measurements, and each piece of equipment may have a different interface to connect to the data calibration engine 204. Non-limiting examples of interfaces include a client 212 within the equipment that provides measurements at a sample rate, an application programming interface (API) 214 that enables the data calibration engine 204 to query for information (e.g., either offline or online), and an offline data store 216. In some aspects, the client 212 may use a standard interface such as a remote procedure call (RPC) to socket-based communication based on a configured reporting rate. The API 214 may be used in equipment to enable the data calibration engine 204 to query the equipment 210 at a customized rate. The API 214 may be used in certain circumstances when data may be transferred asynchronously based on data communications being inconsistent due to transmission losses, noise, and other issues that could affect the integrity of the data. The offline data store 216 may be a fully offline retrieval, such as by connecting a non-volatile memory to the equipment and extracting the recorded data when the equipment is offline.

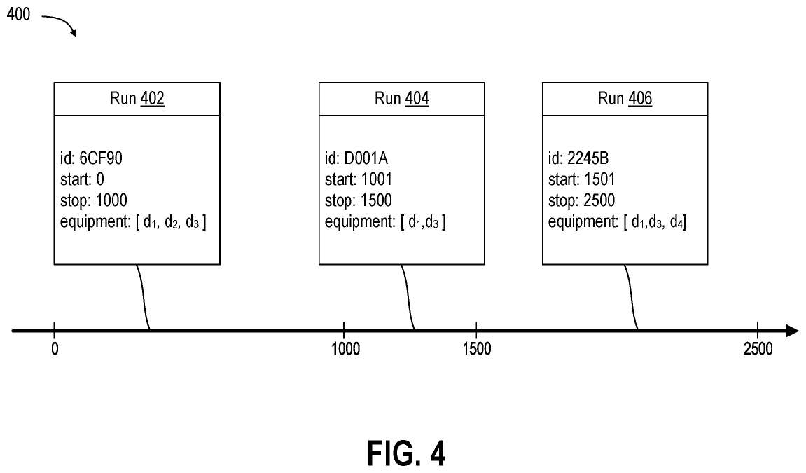

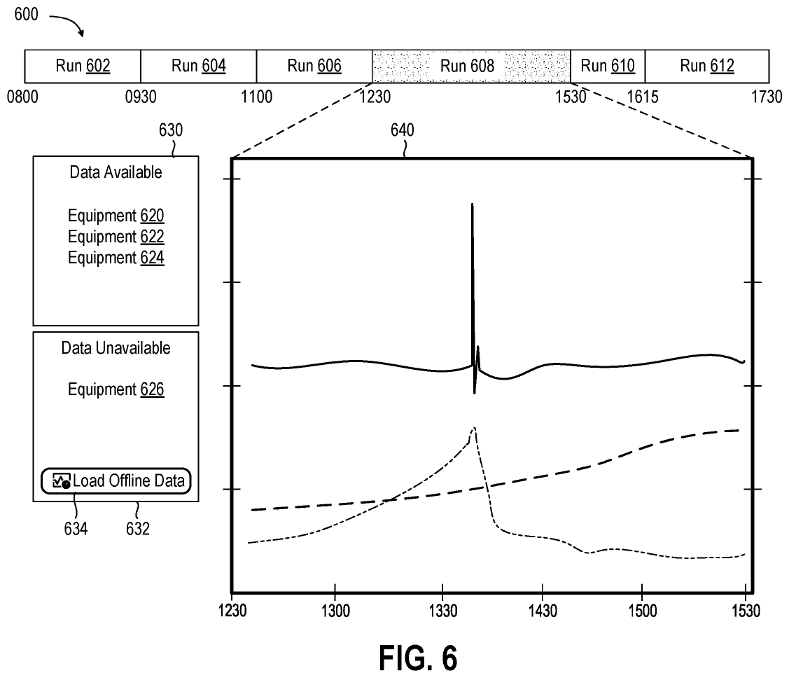

The data calibration engine 204 is configured to retrieve all information from the event database 202 and the equipment 210 and clean the data, and combine the events with the measured data into time-series data. In one aspect, the data calibration engine 204 may identify all events associated with the facility based on the events. For example, an install ticket for a first time indicates the presence of that equipment, and a pull ticket for that same equipment indicates the equipment is pulled. In some aspects, the data calibration engine 204 uses the times of the events within the event database 202 to build a series of runs (or run instances), with each run identifying an equipment configuration. In some aspects, the run may also be a modification of an equipment, such as a device that is recalibrated or configured with a different setting. An example of run instances is further described with reference to FIGS. 4 and 6 and the corresponding descriptions below. Each run represents the usage of the equipment, corresponding settings, and measurements within a single run.

In some aspects, the data calibration engine 204 is configured to combine the data from the equipment 210 into time series data for a time series database. In some aspects, a time series database is optimized for measuring change over time and indexes data based on timestamps. The data calibration engine 204 also incorporates a unique identifier that identifies the run to allow a query to be executed to identify only relevant data associated with the run. In some cases, the data calibration may need to interpolate data based on, for example, data being provided at a lower sample rate.

The data calibration engine 204 is configured to combine data online and offline. Online refers to the system being activated, and offline refers to the system being deactivated. In the case of a submersible pump, the submersible pump is online when pumping fluid while submersed in a well and offline when the pump is not deployed and, for example, is being cleaned after a run.

The data calibration engine 204 may also be configured to align a portion of the data based on various errors associated with the devices. For example, one or more equipment may have a separate clock source and the timestamps may have a different time reference such as an equipment being offset by several seconds. The data calibration engine 204 may ascertain whether to change a timestamp in some scenarios. For example, the data calibration engine may identify that a timestamp has a time zone that is incorrectly configured, and the data calibration engine may modify objectively incorrect timestamp issues. In some cases, the data calibration engine 204 may also be configured to identify timestamp differences between two equipment based on local minima, local maxima, inflection points, and other features that are within a limited range of an event, and then calibrate the timestamps provided by the equipment. For example, a temporary spike in pressure may be a result of physical damage and may cause a downstream effect in another sensor that has a different time reference. The data calibration engine 204 may identify the inflection of the downstream effect in the other sensor and then perform a more detailed analysis to identify if there are similar changes in the dataset (e.g., with multiple runs) that would infer a timestamp differential between the two equipment. The data calibration engine 204 may then calibrate the datasets based on the timestamp differentials to improve the quality of the dataset provided to the time series database. In some cases, the data calibration engine 204 may use a machine learning model (e.g., an encoder) to identify features within a dataset to identify timestamp differentials between different equipment.

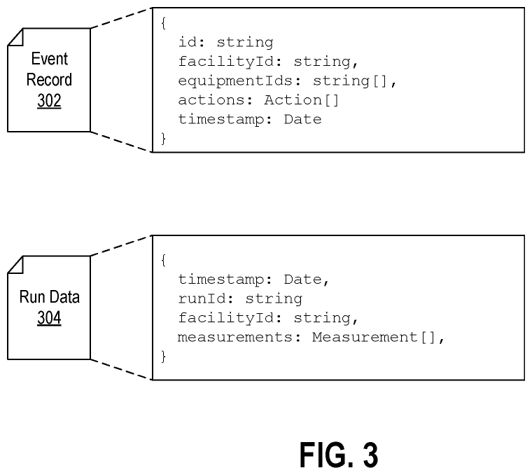

FIG. 3 is an illustration of data formats associated with various records to enable the calibration of run data in accordance with some aspects of the disclosure.

In some aspects, an event record 302 may be stored in a database (e.g., an event database) or other storage mechanism that identifies various events associated with the facility. For example, the event records identify change operations within the facility such as installing an equipment, pulling an equipment for maintenance, changing an operation associated with an equipment, pausing operation due to the presence of a condition, and so forth. The event record 302 includes an identifier (e.g., id) that uniquely identifies the event, for example, a universal unique identifier (UUID) corresponding to request for comment (RFC) 4122. The event record 302 also includes a facility identifier (e.g., facilityId) that uniquely identifies the facility. In some cases, the facilityId may be a well identifier that identifies a geographical location and additional information to identify the precise facility. The event record includes equipment identifiers (e.g., equipmentIds) that specifically identify equipment that is modified at the date and time associated with the timestamp (e.g., a UNIX type Date is a timestamp). As an example, a Date having a value of “1683902816728” indicates the number of milliseconds that have passed since the UNIX epoch (e.g., Jan. 1, 1970), and corresponds to May 12, 2023 10:46:56 GMT-0400 (Eastern Daylight Time).

The event record 302 also includes a list of actions (e.g., actions, which are a list of type Action) that are associated with events that occurred at the timestamp. Non-limiting examples of actions may include installing equipment, pulling equipment for various purposes (e.g., calibration, maintenance, damage), modifying equipment (e.g., changing a direction of a motor, etc.), and so forth. In this case, each event record 302 will have at least one action that represents the change of operation of the facility.

As described above, run data 304 is configured to be stored in a time-series database (e.g., the time-series database 206) and is indexed based on timestamps to allow efficient operations over a period of time. In some cases, a time series database may store massive amounts of data that is recorded over time on an interval (e.g., milliseconds) and the time series database is able to search, retrieve, sum, and other operations based on timestamps in an efficient manner. The run data 304 comprises a timestamp as described above, and the time-series database is configured to index based on timestamps. In one illustrative aspect, the run data 304 also includes a run identifier (e.g., runId) that uniquely identifies a run at a facility identified by the facility identifier (e.g., facilityId). In some cases, the facility identifier may not be included because the facility may be inferred based on the measurements. In some aspects, the run data 304 also includes a list of measurements (e.g., measurements, which is an array of type Measurement). In this case, the measurements may identify a source of a measurement and provide at least one value associated with the measurement. For example, the measurements may be a key-value pair that identifies an equipment and a measurement of that equipment. In some cases, the value may be an integer, a float, or a non-primitive type such as a struct, object, and so forth.

FIG. 4 is a conceptual illustration 400 of run instances based on an operation of a facility in accordance with some aspects of the disclosure. In some aspects, a plurality of runs are illustrated over a period of time on the horizontal axis. A first run 402 starts at time 0 and ends at time 1000, with the value of time corresponding to an arbitrary time for illustrative purposes. For example, each value may be a millisecond in some cases, minutes in some cases, and days in other cases.

In some cases, the event records (e.g., from the event database 202) may be used to identify the equipment and configuration of the facility. In some cases, the event records may identify changes over time by, for example, retrieving all events from a starting point, sorting all events based on date (e.g., presuming that the event records are not ordered implicitly), and determining a state of the facility based on changes. For the first run 402, the facility performs an operation and records data using equipment d₁, equipment d₂, and equipment d₃. For example, the operation may be pumping subterranean fluids from a well using a submersible electric pump.

An event record at time 1000 indicates a change to the facility or the equipment at the facility. In the example illustrated in FIG. 4, equipment d₂ is pulled from the operation for various reasons. For example, the equipment d₂ may be pulled from operation due to required maintenance. In this case, the event record at time 1000 causes the first run to end at time 1000, and the modification causes a second run 404 to be created (e.g., using the data calibration engine 204). In this case, because the equipment d₂ is offline, the facility uses equipment d₁ and equipment d₃ for the operation.

An event record at time 1500 indicates a change to the facility or the equipment at the facility. In this example, equipment da is installed into the operation, which causes the creation of a third run 406. In this case, from time 1501 to time 2500, the facility operates with and records data with equipment d₁, equipment d₂, and equipment d₄. In some aspects, the event record identifies the distinct periods associated with the various runs, which are then used to map the measurement data into a time series database. In some cases, aspects of the disclosure calibrate and clean the run data in connection. Based on aligning all measurements in time, including offline data, the run data may be used to train a machine learning model with greater consistency. In some aspects, calibrating and cleaning the run data enable a machine learning model to identify inferences with less noise and more consistency, thereby reducing false positives and generally improving the training. As noted above, the absence of cleaning and filtering may create significant noise within the datasets, increase training time (and cost), and decrease the machine learning model's accuracy.

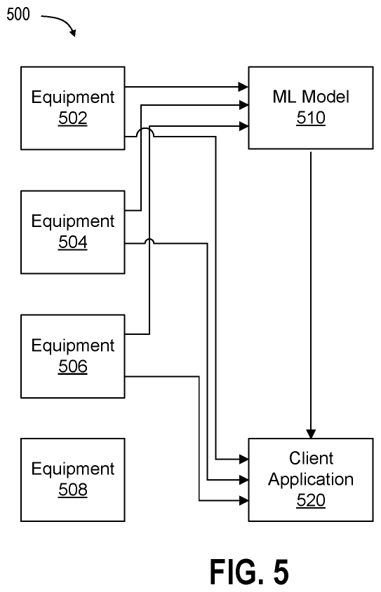

FIG. 5 is a block diagram of a runtime system 500 that uses a machine learning model to facilitate operations of a facility in accordance with some aspects of the disclosure.

In some aspects, the runtime system 500 includes various equipment such as equipment 502, equipment 504, equipment 506, and equipment 508. In some aspects, the 502, the equipment 504, and the equipment 506 are configured to provide runtime (e.g., during operation) information to a machine learning model 510 that is trained to identify adverse condition and mitigate potential issues. For example, the machine learning model 510 may identify conditions based on training that may lead to failure of equipment 508. In this case, the equipment 508 does not provide runtime information because the equipment 508 is deployed and cannot provide information during the operation. In this case, based on training, the machine learning model 510 may infer the conditions and prevent the equipment 508 from experiencing a failure due to the adverse conditions.

The equipment 502, the equipment 504, and the equipment 506 also provide runtime information to a client application 520, which may be saved for later training by calibrating the data using time-series data as described above. The machine learning model 510 may also provide inferences to the client application 520, which may use the inferences to operate the facility. For example, the machine learning model 510 may identify that, based on training, similar situations caused the equipment 508 to fail based on measurements of the equipment 502, the equipment 504, and the equipment 506. In this case, the client application 520 may perform a corrective action autonomously before an operator may intervene. In other cases, the client application 520 may display information to enable an operator to determine whether to perform the corrective action. In other cases, the client application 520 may perform the corrective action and enable the operator to override the corrective action.

FIG. 6 is a user interface 600 associated with a client application of a facility that performs data ingestion associated with equipment, cleaning of the data, and calibrating the data in accordance with some aspects of the disclosure. In some aspects, the user interface 600 displays runs 602-612, corresponding to operation from time 08:00 to 17:30 in a single day. In this case, the user interface 600 receives event data and identifies equipment used during the runs, cleans the data, and enters the data into time-series format for the time-series database (e.g., the time-series database 206). In the user interface 600, run 608 is selected and equipment 620-626 are identified based on the event records in run 608.

In this case, a card 630 is displayed that allows the user to select data from the equipment 620 to 624 that is available from online operation (e.g., recorded during runtime operation). A second card 632 is also displayed that indicates that the equipment 626 is not available and provides a button 634 to allow a user to provide offline data from the equipment 626. In this case, the user interface may not permit a user to proceed without entering the relevant data.

In some aspects, the user interface 600 also includes a graph that displays data that is available to allow a user to consume information related to the operation of the facility. In some aspects, the user interface 600 may also be provided in real-time based on data received during operation.

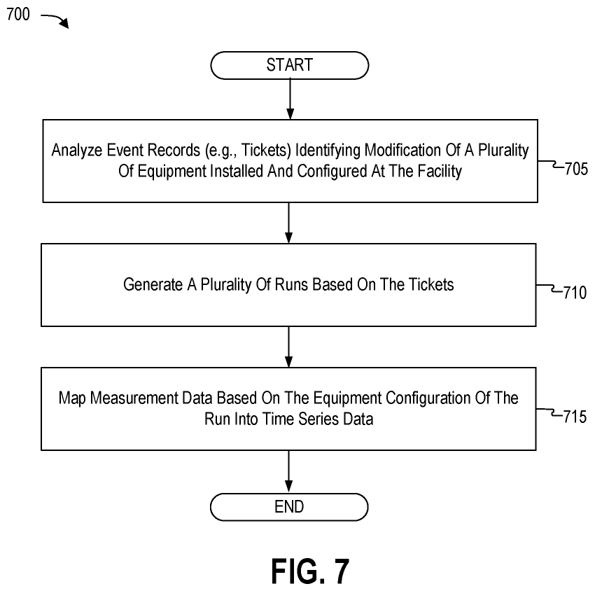

FIG. 7 illustrates an example method 700 for calibrating runtime data of a facility such as a well drilling site or a well pumping site. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

At block 705, a computing system may analyze event records (e.g., tickets) identifying modification of a plurality of equipment installed and configured at the facility. In some examples, the ticket identifies at least one of an installation of a first equipment, removal of the first equipment, maintenance of the first equipment, a modification to the first equipment, and/or testing of the first equipment.

In one example of analyzing event records at block 705, the computing system may determine measurement data of an offline equipment is omitted based on the equipment configuration. In this case, the offline equipment is unable to provide the measurement data during the operation. The computing system may require the user or facility operator to provide the offline data from the offline equipment. In some cases, the offline equipment may disconnect during the operation for various reasons. In this case, the computing system may obtain estimated measurement data of the offline equipment for the portion of the measurement data using a machine learning model. The estimated measurement data is merged into the measurement data because missing data can adversely affect inference and having the machine learning model infer the data associated with the offline equipment may improve inference operation of the entire equipment configuration. In other cases, the offline equipment may be disconnected during the operation.

At block 710 the computing system may generate a plurality of runs based on the tickets. In some aspects, each run of the plurality of runs identifies an equipment configuration, a start time, and an end time. Each run in the plurality of runs represents a distinct duration of time.

In one illustrative example of block 710, the computing system may retrieve the plurality of tickets from a ticket database, which operators of the facility populate during the operation. The ticket database identifies a change to at least one equipment at the facility. The computing system may sort the tickets based on a time associated with each ticket of the plurality of databases. Each start of a run is associated with a first ticket and an end of the run is associated with a second ticket that is next in time to the first ticket.

In some cases, the computing system may need to normalize data due to different sampling rates, or other reasons. In this case, the computing system may determine a common interval based on a measurement interval associated with each equipment in the equipment configuration. The computing system may do different styles of data alignment such as interpolation, but may also calibrate time offsets, align based on regions of time, and so forth. The normalization depends on the data measurements, the sampling rate, and other factors. For example, the computing system may interpolate at least a portion of the measurement data based on the common interval to at least partially normalize the run. The computing system may insert the measurement data for a first equipment of the plurality of equipment at a corresponding time period within the time series data.

At block 715, the computing system may map measurement data based on the equipment configuration of the run into time series data. In some cases, the machine learning model is trained to infer an adverse condition associated with the facility or the plurality of equipment of the facility and a response to mitigate the adverse condition. The time series data is provided to a machine learning model for training operations.

The machine learning model may also be used to perform predictive tasks to assist in various functions of well operation, including well drilling operations and well pumping operations. In one illustrative example, the machine learning model may identify equipment for a future installation, size equipment for a future installation based on different parameters, and so forth. Well diagnostics using the machine learning model may understand the equipment during runtime operations and identify relationships with external factors, such as well conditions, to optimize performance and maximize production.

In some cases, the computing system may also supplement training of a machine learning model (e.g., federated learning) based on additional reliability reports and other information surfaced after the initial training.

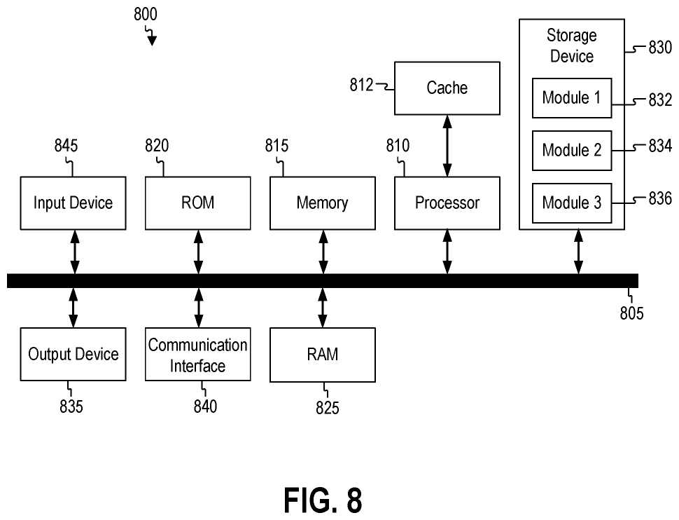

FIG. 8 is a diagram illustrating an example of a system for implementing certain aspects of the present technology. In particular, FIG. 8 illustrates an example of computing system 800, which may be for example any computing device making up an internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some aspects, computing system 800 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example computing system 800 includes at least one processing unit (CPU or processor) 810 and connection 805 that couples various system components including system memory 815, such as ROM 820 and RAM 825 to processor 810. Computing system 800 may include a cache 812 of high-speed memory connected directly with, in close proximity to, or integrated as part of processor 810.

Processor 810 may include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800. Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some aspects, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device may be implemented in circuitry. For example, the components may include and/or may be implemented using electronic circuits or other electronic hardware, which may include one or more programmable electronic circuits (e.g., microprocessors, GPUs, DSPs, CPUs, and/or other suitable electronic circuits), and/or may include and/or be implemented using computer software, firmware, or any combination thereof, to perform the various operations described herein.

In some aspects the computer-readable storage devices, mediums, and memories may include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures may include hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices, or other small form factor personal computers, personal digital assistants, rackmount devices, standalone devices, and so on. The functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method of calibrating measured data, comprising: analyzing a plurality of tickets that identify modification of a plurality of equipment installed and configured at a facility, wherein each ticket identifies at least one of an installation of a first equipment, removal of the first equipment, or testing of the first equipment; generating a plurality of runs associated with an operation of the facility based on the plurality of tickets, wherein a run of the plurality of runs identifies an equipment configuration, a start time, and an end time; and mapping measurement data from the plurality of equipment based on the equipment configuration of the run into time series data.

Aspect 2. The method of Aspect 1, wherein the time series data is provided to a machine learning model for training operations.

Aspect 3. The method of any of Aspects 1 to 2, wherein the machine learning model is trained to infer an adverse condition associated with the facility or the plurality of equipment of the facility and a response to mitigate the adverse condition.

Aspect 4. The method of any of Aspects 1 to 3, wherein each run in the plurality of runs represents a distinct duration of time.

Aspect 5. The method of any of Aspects 1 to 4, further comprising: determining a portion of the measurement data of a first equipment is missing; in response to receiving the measurement data of the offline equipment, inserting the measurement data into the time series data.

Aspect 6. The method of any of Aspects 1 to 5, wherein the portion of the measurement data of the offline equipment is required to be provided before the measurement data from the plurality of equipment is provided to a training dataset or evaluation dataset.

Aspect 7. The method of any of Aspects 1 to 6, wherein the first equipment is offline and is wherein the equipment is unable to provide the measurement data during the operation.

Aspect 8. The method of any of Aspects 1 to 7, further comprising: obtaining estimated measurement data of the first equipment for the portion of the measurement data using a machine learning model, wherein the estimated measurement data is merged into the measurement data, and wherein a connection to the first equipment is interrupted for a period associated with the portion of the measurement data.

Aspect 9. The method of any of Aspects 1 to 8, further comprising: determining a common interval based on a measurement interval associated with each equipment in the equipment configuration; and interpolating at least a portion of the measurement data based on the common interval to at least partially normalize each run.

Aspect 10. The method of any of Aspects 1 to 9, wherein generating the plurality of runs comprises: retrieving the plurality of tickets from a ticket database, wherein the ticket database identifies a change to at least one equipment at the facility; sorting the plurality of tickets based on a time associated with each ticket of the plurality of tickets, wherein each a start of a run is associated with a first ticket and an end of the run is associated with a second ticket that is next in time to the first ticket.

Aspect 11. The method of any of Aspects 1 to 10, wherein mapping the measurement data from the plurality of equipment into the time series data comprises: determining a time offset associated with first measurement data of the first equipment; and correcting timestamps of the first measurement data of the first equipment based on the time offset.

Aspect 12. The method of any of Aspects 1 to 11, wherein a machine learning model is configured to determine the time offset based on the measurement data of the plurality of equipment.

Aspect 13. A system for calibrating measured data includes a storage (implemented in circuitry) configured to store instructions and a processor. The processor configured to execute the instructions and cause the processor to: analyze a plurality of tickets that identify modification of a plurality of equipment installed and configured at a facility, wherein each ticket identifies at least one of an installation of a first equipment, removal of the first equipment, or testing of the first equipment; generate a plurality of runs associated with an operation of the facility based on the plurality of tickets, wherein a run of the plurality of runs identifies an equipment configuration, a start time, and an end time; and mapping measurement data from the plurality of equipment based on the equipment configuration of the run into time series data.

Aspect 14. The system of Aspect 13, wherein the time series data is provided to a machine learning model for training operations.

Aspect 15. The system of any of Aspects 13 to 14, wherein the machine learning model is trained to infer an adverse condition associated with the facility or the plurality of equipment of the facility and a response to mitigate the adverse condition.

Aspect 16. The system of any of Aspects 13 to 15, wherein each run in the plurality of runs represents a distinct duration of time.

Aspect 17. The system of any of Aspects 13 to 16, wherein the processor is configured to execute the instructions and cause the processor to: determine a portion of the measurement data of a first equipment is missing; in response to receiving the measurement data of the offline equipment, insert the measurement data into the time series data.

Aspect 18. The system of any of Aspects 13 to 17, wherein the portion of the measurement data of the offline equipment is required to be provided before the measurement data from the plurality of equipment is provided to a training dataset or evaluation dataset.

Aspect 19. The system of any of Aspects 13 to 18, wherein the first equipment is offline and is wherein the equipment is unable to provide the measurement data during the operation.

Aspect 20. The system of any of Aspects 13 to 19, wherein the processor is configured to execute the instructions and cause the processor to: obtain estimated measurement data of the first equipment for the portion of the measurement data using a machine learning model, wherein the estimated measurement data is merged into the measurement data, and wherein a connection to the first equipment is interrupted for a period associated with the portion of the measurement data.

Aspect 21. The system of any of Aspects 13 to 20, wherein the processor is configured to execute the instructions and cause the processor to: determine a common interval based on a measurement interval associated with each equipment in the equipment configuration; and interpolate at least a portion of the measurement data based on the common interval to at least partially normalize each run.

Aspect 22. The system of any of Aspects 13 to 21, wherein the processor is configured to execute the instructions and cause the processor to: retrieve the plurality of tickets from a ticket database, wherein the ticket database identifies a change to at least one equipment at the facility; sort the plurality of tickets based on a time associated with each ticket of the plurality of tickets, wherein each a start of a run is associated with a first ticket and an end of the run is associated with a second ticket that is next in time to the first ticket.

Aspect 23. The system of any of Aspects 13 to 22, wherein the processor is configured to execute the instructions and cause the processor to: determine a time offset associated with first measurement data of the first equipment; and correct timestamps of the first measurement data of the first equipment based on the time offset.

Aspect 24. The system of any of Aspects 13 to 23, wherein a machine learning model is configured to determine the time offset based on the measurement data of the plurality of equipment.

Aspect 25. A non-transitory computer-readable storage medium comprising instructions stored thereon which, when executed by at least one processor, causes the at least one processor to perform operations according to any of Aspects 1 to 12.

Aspect 26. An apparatus for calibrating reliability records comprising one or more means for performing operations according to any of Aspects 1 to 12.

What is claimed is:

1. A method of calibrating measured data, comprising:
analyzing a plurality of tickets that identify modification of a plurality of equipment installed and configured at a facility, wherein each ticket identifies at least one of an installation of a first equipment, removal of the first equipment, or testing of the first equipment;
generating a plurality of runs associated with an operation of the facility based on the plurality of tickets, wherein a run of the plurality of runs identifies an equipment configuration, a start time, and an end time; and
mapping measurement data from the plurality of equipment based on the equipment configuration of the run into time series data.

2. The method of claim 1, wherein the time series data is provided to a machine learning model for training operations.

3. The method of claim 2, wherein the machine learning model is trained to infer an adverse condition associated with the facility or the plurality of equipment of the facility and a response to mitigate the adverse condition.

4. The method of claim 1, wherein each run in the plurality of runs represents a distinct duration of time.

5. The method of claim 1, further comprising:
determining a portion of the measurement data of a first equipment is missing;
in response to receiving the measurement data of the offline equipment, inserting the measurement data into the time series data.

6. The method of claim 5, wherein the portion of the measurement data of the offline equipment is required to be provided before the measurement data from the plurality of equipment is provided to a training dataset or evaluation dataset.

7. The method of claim 5, wherein the first equipment is offline and the equipment is unable to provide the measurement data during the operation.

8. The method of claim 5, further comprising:
obtaining estimated measurement data of the first equipment for the portion of the measurement data using a machine learning model,
wherein the estimated measurement data is merged into the measurement data, and
wherein a connection to the first equipment is interrupted for a period associated with the portion of the measurement data.

9. The method of claim 1, further comprising:
determining a common interval based on a measurement interval associated with each equipment in the equipment configuration; and
interpolating at least a portion of the measurement data based on the common interval to at least partially normalize each run.

10. The method of claim 1, wherein generating the plurality of runs comprises:
retrieving the plurality of tickets from a ticket database, wherein the ticket database identifies a change to at least one equipment at the facility;
sorting the plurality of tickets based on a time associated with each ticket of the plurality of tickets, wherein each a start of a run is associated with a first ticket and an end of the run is associated with a second ticket that is next in time to the first ticket.

11. The method of claim 1, wherein mapping the measurement data from the plurality of equipment into the time series data comprises:
determining a time offset associated with first measurement data of the first equipment; and
correcting timestamps of the first measurement data of the first equipment based on the time offset.

12. The method of claim 11, wherein a machine learning model is configured to determine the time offset based on the measurement data of the plurality of equipment.

13. A system for calibrating measured data, comprising:
a storage configured to store instructions;
a processor configured to execute the instructions and cause the processor to:
analyze a plurality of tickets that identify modification of a plurality of equipment installed and configured at a facility, wherein each ticket identifies at least one of an installation of a first equipment, removal of the first equipment, or testing of the first equipment;
generate a plurality of runs associated with an operation of the facility based on the plurality of tickets, wherein a run of the plurality of runs identifies an equipment configuration, a start time, and an end time; and
mapping measurement data from the plurality of equipment based on the equipment configuration of the run into time series data.

14. The system of claim 13, wherein the time series data is provided to a machine learning model for training operations.

15. The system of claim 14, wherein the machine learning model is trained to infer an adverse condition associated with the facility or the plurality of equipment of the facility and a response to mitigate the adverse condition.

16. The system of claim 13, wherein each run in the plurality of runs represents a distinct duration of time.

17. The system of claim 13, wherein the processor is configured to execute the instructions and cause the processor to:
determine a portion of the measurement data of a first equipment is missing;
in response to receiving the measurement data of the offline equipment, insert the measurement data into the time series data.

18. The system of claim 17, wherein the portion of the measurement data of the offline equipment is required to be provided before the measurement data from the plurality of equipment is provided to a training dataset or evaluation dataset.

19. The system of claim 17, wherein the first equipment is offline and is wherein the equipment is unable to provide the measurement data during the operation.

20. The system of claim 17, wherein the processor is configured to execute the instructions and cause the processor to:
obtain estimated measurement data of the first equipment for the portion of the measurement data using a machine learning model,
wherein the estimated measurement data is merged into the measurement data, and
wherein a connection to the first equipment is interrupted for a period associated with the portion of the measurement data.
